(19) United States
(12) Patent Application Publication
(10) Pub. No.: US 2016/0208749 A1
(43) Pub. Date: Jul. 21, 2016

(54) Multi-Fuel Engine And Method Of Operating The Same

(71) Applicant: Caterpillar Inc., Peoria, IL (US)

(72) Inventors: Arvind Sivasubramanian, Peoria, IL (US); Vijay Turlapati, Peoria, IL (US); Christopher Gallmeyer, Chillicothe, IL (US); Jason Rasmussen, Hopewell, IL (US)

(73) Assignee: Caterpillar Inc., Peoria, IL (US)

(21) Appl. No.: 14/600,841

(22) Filed: Jan. 20, 2015

(51) Int. Cl. F02M 43/04

(52) U.S. Cl. CPC F02M 43/04

(57) ABSTRACT

A method for controlling fuel flow in a multi-fuel engine is disclosed. The method includes determining an estimated lower heating value (LHV) of a gaseous fuel by, at least, comparing a mapped volume flow value with an input volume flow value, the input volume flow value based on the input power. The method further includes determining a gaseous fuel flow rate for the gaseous fuel, the gaseous fuel flow rate based on, at least, a specific fuel substitution ratio of the gaseous fuel and a secondary fuel and the estimate LHV of the gaseous fuel source.

### TECHNICAL FIELD

The present disclosure generally relates to internal combustion engines and, more particularly, relates to multi-fuel engines capable of operating with various types of fuel.

### BACKGROUND

Multi-fuel engines are, generally, any type of engine, boiler, heater, or other fuel-burning device which is designed to burn multiple types of fuels during operation. Such multi-fuel engines may be used in various applicable areas to meet particular operational needs associated with an operating environment. For example, multi-fuel engines may be used in military vehicles so that vehicles in various deployment locations may utilize a wide range of alternative fuels such as gasoline, diesel, or aviation fuel. Multi-fuel engines are especially desirable where cheaper fuel sources, such as natural gas, are available but an alternative or secondary fuel, such as diesel fuel, is needed for performance reasons (e.g., faster reaction to short term load demands), as a backup in the event of an interruption in the supply of the primary fuel source, or for other operation or engine performance conditions.

Typically, multi-fuel engines may operate with a specified mixture of the available fuels. If a liquid-only fuel mixture is specified, a liquid fuel (e.g., diesel fuel, gasoline, or any other liquid hydrocarbon fuel) is injected directly into an engine cylinder or a pre-combustion chamber, as the sole source of energy during combustion. When a liquid and gaseous fuel mixture is specified, a gaseous fuel (e.g., natural gas, methane, hexane, pentane, or any other appropriate gaseous hydrocarbon fuel) may be mixed with air in an intake port of a cylinder and a small amount or pilot amount of liquid fuel is injected into the cylinder or pre-combustion chamber in an amount according to a specified substitution ratio in order to ignite the mixture of air and gaseous fuel.

Some multi-fuel engines have been designed having an engine speed controller that acts on speed error to set a fuel rate. For engines that can run on multiple fuels, multiple fuel rates are set based on the fuel fraction or desired ratio of fuels. However, prior typical speed controllers (e.g., a proportional-integral (PI) controller) can only set a fuel rate for a single fuel. In such scenarios, each PI controller for each fuel would set an individual fuel rate for the corresponding fuel while ignoring that there are other fuels supplying power to the engine; as if the other fuels did not exist. These engine speed controllers required significant design time and effort required for multiple PI controllers and also involved complex switching strategies to ensure an overall robust design.

Therefore, multi-fuel engine control strategies have been developed to simplify the process for determining fuel flow rates for various fuels available to the engine. Such control strategies are disclosed, for example, in U.S. patent application Ser. No. 13/919,166 (“Fuel Apportionment for Multi-fuel Engine System”). In the aforementioned disclosure, multi-fuel engine control strategies are disclosed that determine an input power for operating the engine using a PI controller and a fuel flow rate for each fuel is determined using a fuel apportionment module. Such fuel apportionment modules may base the apportionment on a specific fuel ratio and required input power. The control system can perform apportionment for multiple fuels while not requiring multiple PI controllers.

However, when using gaseous fuels as one or more fuel sources in a multi-fuel engine, the relative energy contained in the given fuel or fuels will necessarily affect engine performance. Therefore, a need exists to account for such varying fuel energy levels in a multi-fuel engine.

### SUMMARY

In accordance with one aspect of the disclosure, a method for controlling fuel flow in a multi-fuel engine is disclosed. The multi-fuel engine has power provided to it by, at least, a gaseous fuel source and a secondary fuel source. The method may include determining an input power for operating the multi-fuel engine at a desired engine speed. The method may further include determining a secondary fuel flow rate for the secondary fuel source based on, at least, the input power and a specified fuel substitution ratio for apportioning the secondary fuel source and the gaseous fuel source. The method may further include determining an estimated lower heating value (LHV) of the gaseous fuel by, at least, comparing a mapped volume flow value with an input volume flow value, the input volume flow value based on the input power. The method may further include determining a gaseous fuel flow rate for the gaseous fuel, the gaseous fuel flow rate based on, at least, the specific fuel substitution ratio and the estimate LHV of the gaseous fuel source.

In accordance with another aspect of the disclosure, a multi-fuel engine is disclosed. The multi-fuel engine may be provided with power by, at least, a gaseous fuel source and a secondary fuel source. The multi-fuel engine may include at least one cylinder, a fuel injector operatively associated with the at least one cylinder, and a fuel control valve operatively associated with the at least one cylinder. The multi-fuel engine may include an engine speed control configured to output an engine speed control signal indicating a desired engine speed, a speed controller for determining an input power based on, at least, the desired engine speed, and a fuel mix input control for providing a specified fuel substitution ratio for the gaseous fuel source and the secondary fuel source. The multi-fuel engine may further include a LHV estimator for determining an estimated LHV of the gaseous fuel by, at least, comparing a mapped volume flow value with an input volume flow value, the input volume flow value based on the input power. The multi-fuel engine may further include a fuel apportionment module for determining a secondary fuel flow rate for the secondary fuel source based on, at least, the input power and the specified fuel substitution ratio and for determining a gaseous fuel flow rate for the gaseous fuel, the gaseous fuel flow rate based on, at least the specific fuel substitution ratio and the estimated LHV of the gaseous fuel source. The multi-fuel engine may further include a first actuator for directing the fuel control valve to output the gaseous fuel to the multi-fuel engine at the gaseous fuel flow rate and a second actuator for directing the fuel injector to output the secondary fuel to the multi-fuel engine at the secondary fuel flow rate.

In accordance with yet another aspect of the disclosure, a method for dynamically determining the lower heating value (LHV) of a gaseous fuel in a multi-fuel engine is disclosed. The multi-fuel engine may be fueled by, at least, the gaseous fuel and a secondary fuel. The method may include receiving a calculated volume flow value for the multi-fuel engine from a controller associated with the multi-fuel engine and receiving a measured engine speed from an engine speed sensor associated with the multi-fuel engine. The method may further include determining a measured indicated mean effective pressure (IMEP) of the multi-fuel engine based on input from a sensor and determining a mapped volume flow value based on the measured engine speed and the IMEP. The method may further include comparing the mapped volume flow value with the calculated volume flow value to determine a volume flow error and determining the LHV of the gaseous fuel based on, at least, the volume flow error.

These and other aspects and features of the present disclosure will be better understood when read in conjunction with the accompanying drawings.

### BRIEF DESCRIPTION OF THE DRAWINGS

FIG. 1 is a schematic view of an example multi-fuel engine system in accordance with the present disclosure.

FIG. 2 is a schematic block diagram of an example electronic control unit and control components that may be implemented in association with the multi-fuel engine system of FIG. 1.

FIG. 3 is a schematic block diagram of an example fuel apportionment system in accordance with the electronic control unit of FIG. 2 and the multi-fuel engine system of FIG. 1.

FIG. 4 is a schematic block diagram of an example fuel apportionment module in association with the fuel apportionment system of FIG. 3.

FIG. 5 is a schematic block diagram of an example dynamic, indicated mean effective pressure (IMEP) based, lower heating value (LHV) estimator in association with the fuel apportionment system of FIG. 3.

FIG. 6 is a flowchart of an exemplary method for controlling fuel flow in a multi-fuel engine, the multi-fuel engine being provided power by, at least, a gaseous fuel source and a secondary fuel source in accordance with the present disclosure.

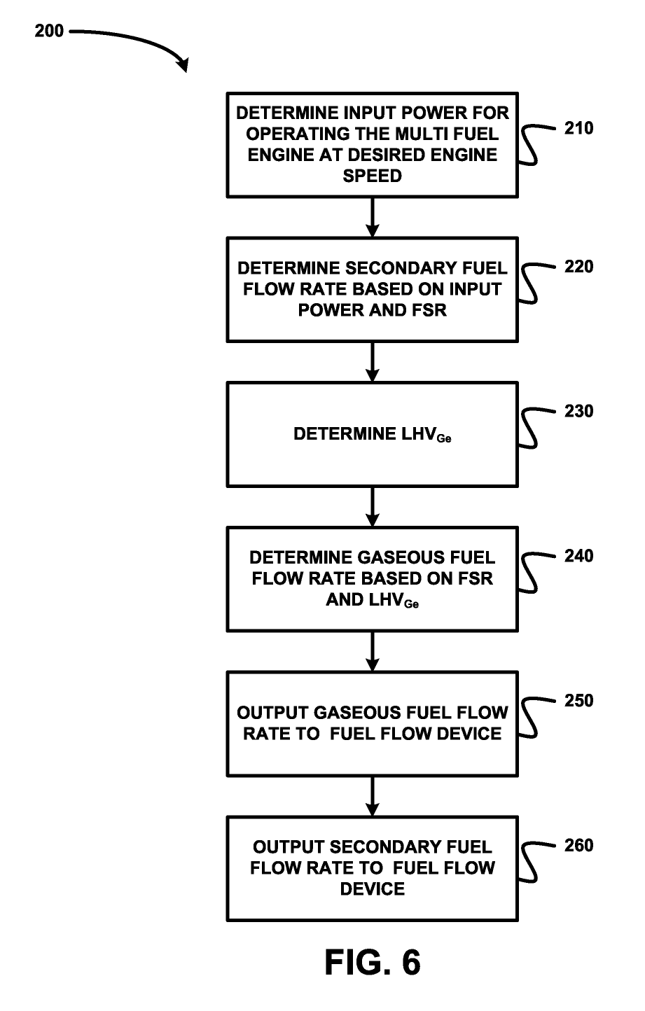

FIG. 7 is a flowchart of an exemplary method for dynamically determining the LHV of a gaseous fuel in a multi-fuel engine, wherein the multi-fuel engine is fueled by, at least, the gaseous fuel and a secondary fuel, in accordance with the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

The present disclosure provides systems and methods for controlling and adapting apportionment of multiple fuels to a multi-fuel engine based on a lower heating value (LHV) of a gaseous fuel. Such systems and methods may automatically adapt to a changing LHV of a gaseous fuel based on an indicated mean effective pressure (IMEP) of the gaseous fuel. A mean effective pressure, generally, is a quantity relating to the operation of an engine and may be valuable in measuring an engine's capacity to do work independent of engine displacement. More specifically, an indicated mean effective pressure (IMEP) is a mean effective pressure calculated from in-cylinder pressure over the engine's cycle. In multi-fuel engines, the IMEP may be calculated based on measured pressures in areas of the engine like, for example, a measure of the pressure at a cylinder of the engine.

Ratios of fuels in a multi-fuel engine may be affected by the lower heating value (LHV) of the fuel(s). LHV may be understood as the enthalpy of all combustion products, minus the enthalpy of the fuel at the reference temperature, minus the enthalpy of the stoichiometric oxygen at the reference temperature, minus the heat of vaporization of the vapor content of the combustion products. LHV is known to give an approximate representation of energy contained within a given fuel.

The LHV for liquid fuels (such as a diesel fuel) is often constant and, therefore, variance of liquid LHV is, generally, not accounted for in calculation of fuel ratios. However, the LHV of gaseous fuels can change. If the change in LHV of the gaseous fuel is not accounted for, then the engine may run at the wrong ratio of liquid to gaseous fuels and/or the change in LHV may affect engine performance and emissions. In some instances, changes in LHV may be damaging to the engine.

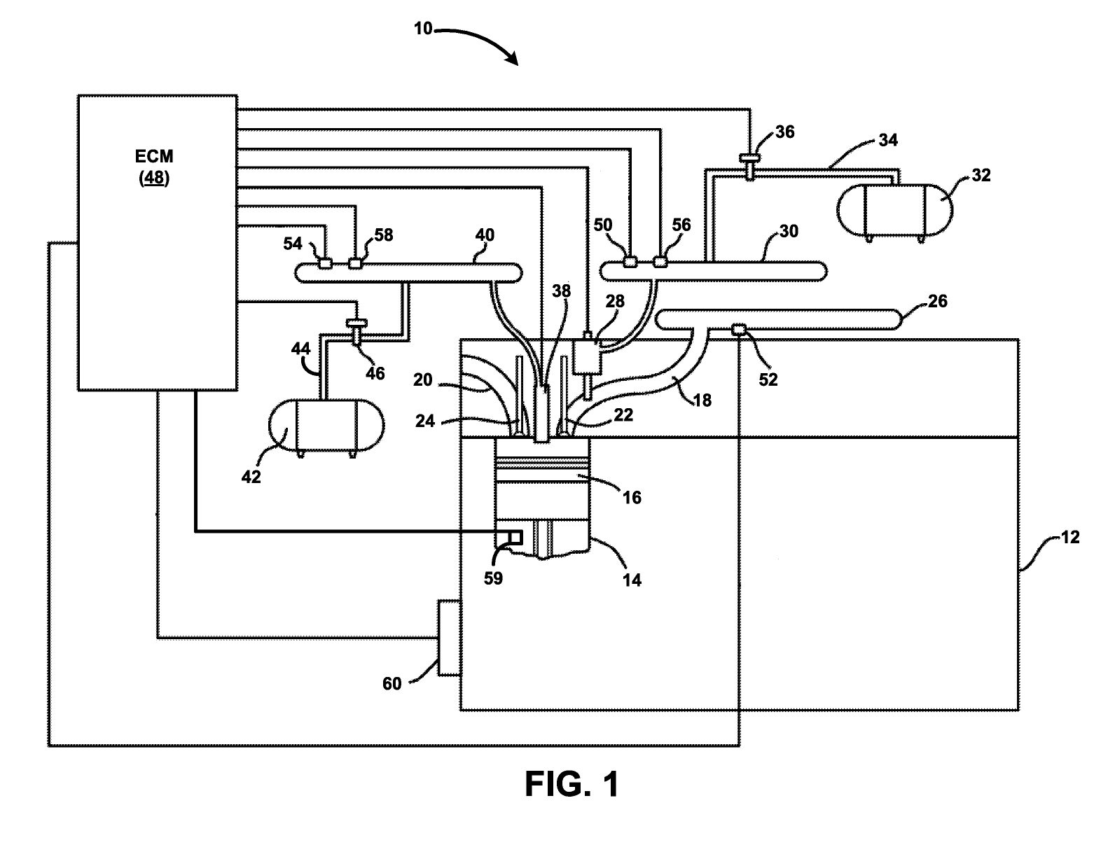

Turning now to the drawings, and with specific reference to FIG. 1, a multi-fuel engine system 10 is shown. The engine system 10 may be any type of internal combustion engine including, but not limited to, Otto cycle and Diesel cycle engines. The multi-fuel engine system 10 may include a multi-fuel engine 12 with a representative cylinder 14 of a plurality of cylinders 14 implemented in the engine 12. Although only one cylinder 14 is shown, it is recognized that the actual number of cylinders 14 of the engine 12 could vary and that the engine 12 could be of the in-line type, V-type, or even a rotary type engine. A piston 16 is positioned for displacement within the cylinder 14, and the cylinder 14 includes an intake port 18, and an exhaust port 20. The cylinder may further include an intake valve 22 for regulating the fluid communication between the cylinder 14 and the intake port 18 and an exhaust valve 24 for regulating the fluid communication between the cylinder 14 and the exhaust port 20. The intake port 18 receives air from an air intake manifold 26 to which intake air travels after passing through, for example, an air filter (not shown) and turbo charger (not shown).

A gaseous fuel admission valve 28 of a type commonly known in the art is positioned between a gaseous fuel manifold 30 at an upstream side and the intake port 18 at a downstream side. A nozzle portion of valve 28 may extend into the intake port 18 for delivering gaseous fuel thereto and mixing with the air from the air intake manifold 26. The gaseous fuel manifold 30 is connected to a gaseous fuel source 32 by a fuel path 34, and a solenoid operated gaseous fuel shut off valve 36 may be positioned along the fuel path 34. The gaseous fuel source 32 may provide any appropriate gaseous fuel that may be used in the multi-fuel engine 12, such as natural gas, methane, hexane, pentane or any other gaseous hydrocarbon fuel. Although not shown, it is recognized that such a system might typically include a balance regulator positioned between the gaseous fuel source 32 and the gaseous fuel manifold 30 for regulating the gaseous fuel pressure at the upstream side of the gaseous fuel admission valve 28.

The engine 12 may further include a liquid fuel injector 38, such as an electronic unit injector, for injecting liquid fuel, such as diesel fuel, into the cylinder 14. The liquid fuel may be provided to the fuel injector 38 via a common rail 40 supplying each of the cylinders 14 of the engine 12 with pressurized liquid fuel transmitted to the common rail 40 from a pressurized liquid fuel source 42 via a liquid fuel path 44. A solenoid operated liquid fuel shut off valve 46 may be positioned along the liquid fuel path 44 to cut off the flow of liquid fuel if necessary. The exhaust port 20 fluidly connects the cylinder 14 to an emissions portion (not shown) of the multi-fuel engine system 10 to discharge the exhaust created by the combustion of the fuels from the cylinder 14.

An electronic control module (ECM) 48 of the multi-fuel engine system 10 may be connected to a gaseous fuel pressure sensor 50, to an intake air pressure sensor 52, and to a liquid fuel pressure sensor 54. Such pressure sensors 50, 52, 54 produce pressure indicative signals and are well known in the art; therefore, a detailed description of the sensors 50, 52, 54 is not included herein. Temperature sensors 56, 58 are also provided in the gaseous fuel manifold 30 and the common rail 40, respectively, to provide temperature indicative signals to the ECM 48. The pressure sensors 50, 52, 54 and temperature sensors 56, 58 may be connected to the ECM 48 by any conductive path suitable for sending and/or receiving electrical signals produced by either the ECM 48 or the sensors 50, 52, 54, 56, 58.

Further, the ECM 48 is operatively connected to the gaseous fuel admission valve 28 to control gaseous fuel admission. The ECM 48 and is further connected to the fuel injector 38 to control liquid fuel flow. In this regard it is known to include driver circuitry or software within the ECM 48 for delivering current control signals to the gaseous fuel admission valve 28 and the fuel injector 38 to control the flow rates of the corresponding fuels there through. However, it is recognized that such driver circuitry could be implemented separate from, but connected to, the ECM 48.

In some examples, the engine system 10 may include an indicated mean effective pressure (IMEP) sensor 59 for determining an IMEP of at least one cylinder 14 of the engine 12. The IMEP sensor 59 may use the pressure at the cylinder 14, among other measurements, to determine the IMEP of the engine 12 and transmit signals representative of an engine IMEP to the ECM 48. The IMEP sensor 59 may transmit pressure reading signals determined at the cylinder 14, from which the ECM 48 may determine an IMEP value. Additionally or alternatively, the IMEP sensor 59 may transmit a determined IMEP signal. Further, an engine speed sensor 60 associated with a camshaft or other component of the engine 12 from which the engine speed may be determined may also be connected to the ECM 48 for delivering engine speed indicative signals thereto.

The multi-fuel engine system 10 as shown can operate in a liquid fuel mode or a multi-fuel mode. In the liquid fuel mode, the gaseous fuel admission valve 28 remains closed while pressurized liquid fuel is injected into the engine cylinder 14 by the fuel injector 38 as the sole source of fuel energy during combustion. In the multi-fuel mode, the gaseous fuel from the gaseous fuel source 32 is discharged into the intake port 18 by the gaseous fuel admission valve 28 and mixed with air from air intake manifold 26, and a small amount or pilot amount of the pressurized liquid fuel is injected into cylinder 14 at the fuel injector 38 in order to ignite the mixture of air and gaseous fuel. Those skilled in the art will understand that the configuration of the multi-fuel engine system 10 shown in FIG. 1 and described herein is exemplary only, and other configurations are contemplated for implementation of the multi-fuel engine control strategy in accordance with the present disclosure. For example, the multi-fuel engine system 10 may be configured to be powered by additional types of gaseous and liquid fuels, and the multi-fuel engine control strategy may be configured to allow specification of substitution ratios for apportioning the input power required by the engine 12 between the available fuels.

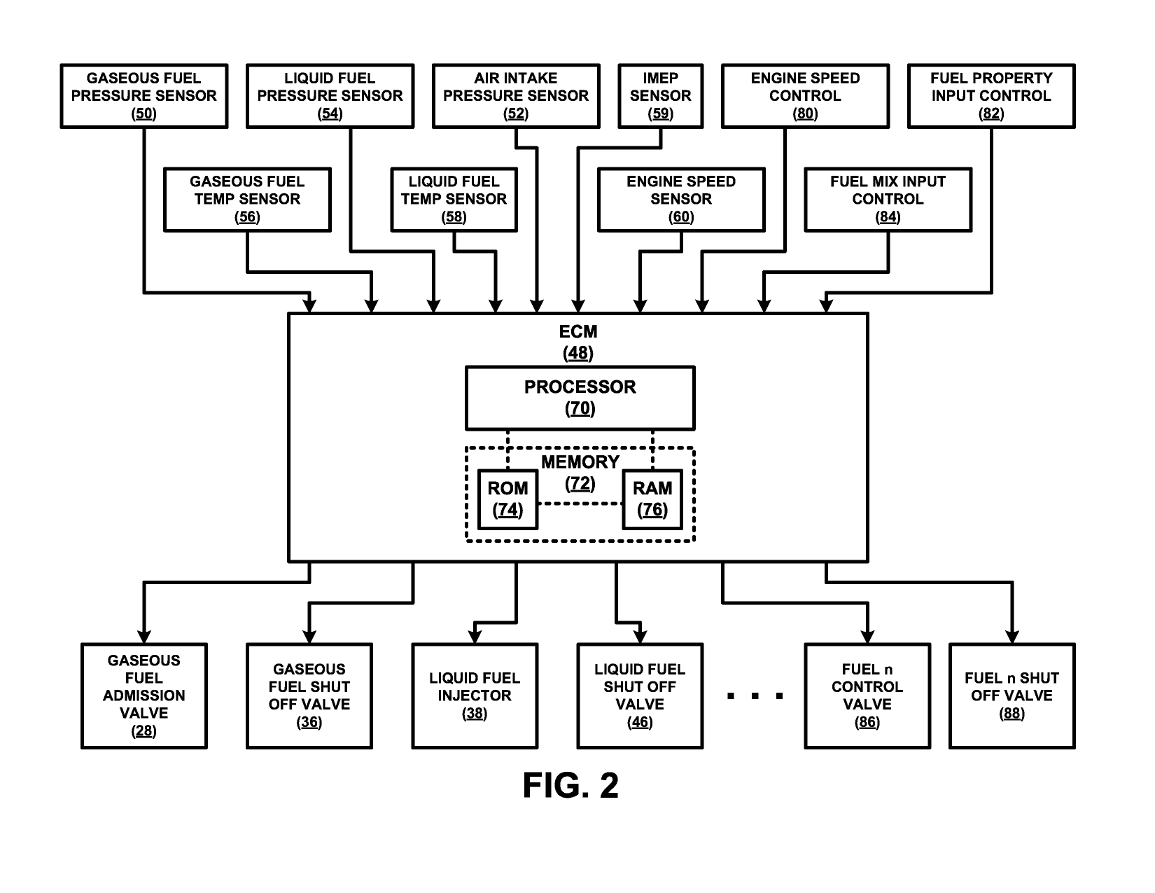

FIG. 2 illustrates an exemplary configuration of the ECM 48 that may be implemented in the multi-fuel engine system 10 to control the operation of the engine 12 and the apportionment of fuels to provide the required power to the engine 12, and, if desired, to control the operations of other systems that are integrated with the multi-fuel engine system 10. The ECM 48 may include a processor 70 for executing specified programs that control and monitor various functions associated with the system 10. The processor 70 be associated with a memory 72, such as read only memory (ROM) 74, for storing a program or programs, and a random access memory (RAM) 76 which serves as a working memory area for use in executing the program(s) stored in the memory 72. While the processor 70 is referenced, generally, as a processor, it may be implemented using one or more of a variety of electronic components such as microprocessors, microcontrollers, an ASIC (application specific integrated circuit) chips, or any other integrated circuit devices.

The ECM 48 electrically connects to the control elements of the multi-fuel engine system 10, as well as various input devices for commanding the operation of the engine 12 and monitoring its performance. As a result, the ECM 48 may be electrically connected to the pressure sensors 50, 52, 54, temperature sensors 56, 58, IMEP sensor 59, and engine speed sensor 60 as discussed above to receive parameter value indicative signals relating to the operating conditions of the engine 12. The ECM 48 may also be electrically connected to input devices such as, for example, an engine speed control 80, a fuel property input control 82 and a fuel mix input control 84. An operator of the multi-fuel engine system 10 may manipulate the controls 80, 82, 84 to generate and transmit control signals to the ECM 48 with commands for operating the engine 12 as desired to produce the necessary engine speed with a desired apportionment of the available fuels. The engine speed control 80 may be any type of input device allowing an operator to specify a speed at which the engine 12 should operate to provide the output necessary to perform a desired task. For example, the engine speed control 80 could be a gas pedal of a vehicle or excavating machine, a thrust lever of an airplane, or other appropriate input device for specifying the speed of the engine 12.

The fuel property input control 82 may be any appropriate input device allowing an operator, technician or other user of the multi-fuel engine system 10 to input information regarding the properties of the fuels available for use by the system 10. The fuel property data input may include any data necessary for the system 10 to determine an amount of a fuel necessary for producing an amount of power in the engine 12 to meet a power requirement determined as discussed further below. Examples of fuel property data that may be specified for a fuel available to the engine 12 include the density or specific gravity of the fuel, the heat of combustion of the fuel expressed as, for example, an original lower heating value (LHV) indicating the energy released by the fuel per unit of mass or volume, and the like. The fuel property input control 82 may be a computer terminal or other similar input device connected to the ECM 48 and allowing a user to input the fuel property data and transmit the data to the ECM 48. In alternative embodiments, the fuel property input control 82 may be a remote computing device or computing system connected via a network to transmit fuel property data to the multi-fuel engine system 10 from a remote location, such as a central control center, managing the operation of the system 10 in conjunction with the ECM 48. As a further alternative, the fuel property input control 82 may be an external storage device, such as a magnetic, optical or solid state storage device, on which the fuel property data is stored and downloaded to the ECM 48 when the external storage device is connected to the ECM 48. Further alternative devices for inputting fuel property data and transferring the data to the ECM 48, which can be a direct connection or a wireless connection, will be apparent to those skilled in the art and are contemplated by the inventors as having use in multi-fuel engine systems in accordance with the present disclosure.

The fuel mix input control 84 may be any appropriate input device allowing an operator, technician or other user of the multi-fuel engine system 10 to input information regarding the apportionment of the fuels available for use by the system 10. The fuel mix data input at the fuel mix input control 84 may specify fuel substitution ratios or fractions for usage of each of the available fuels for meeting the desired engine speed input power necessary to operate the engine 12 at the engine speed specified at the engine speed control 80. For example, in a dual fuel engine operating with a gaseous fuel (e.g., natural gas) and a liquid fuel (e.g., diesel fuel), it may be desired to have the gaseous fuel provide 80% of the power requirement and have the liquid fuel provide the remaining 20% of the power requirement. In such a case, a substitution ratio of 20%, or 0.20, may be input at the fuel mix input control 84 and stored at the ECM 48 so that the liquid fuel will be substituted for the gaseous fuel and provide 20% of the power. Where more fuels are available, a fuel substitution ratio or fraction may be input for each fuel, with the individual substitution ratios totaling 100%, or 1.00, so that the power supplied by the individual fuels adds up to the total input power required for the engine 12. The fuel mix input control 84 may be a similar input device as those discussed above for the fuel property input control 82. In some embodiments, the input controls 82, 84 may be implemented in the same input device, such as a graphical user interface located within an operator station and having a series of screens allowing an operator to input the fuel property data and the fuel mix data.

The ECM 48 may also be electrically connect to actuators and transmit control signals to the actuators to cause the various elements of the multi-fuel engine system 10 to operate. Consequently, actuators for fluid flow control devices such as the gaseous fuel admission valve 28, the liquid fuel injector 38 and the shut off valves 36, 46 may be connected to the ECM 48 and receive control signals from the ECM 48 to operate the corresponding valves 28, 36, 46 and the fuel injector 38 to control flow of the gaseous and liquid fuels. Alternate implementations of the system 10 may allow the engine 12 to be powered by additional fuels that may be available. In those implementations, an additional fuel control valve 86 and shut off valve 88 may be provided to control the flow of the additional fuels up to an n^{th} fuel used in the system 10.

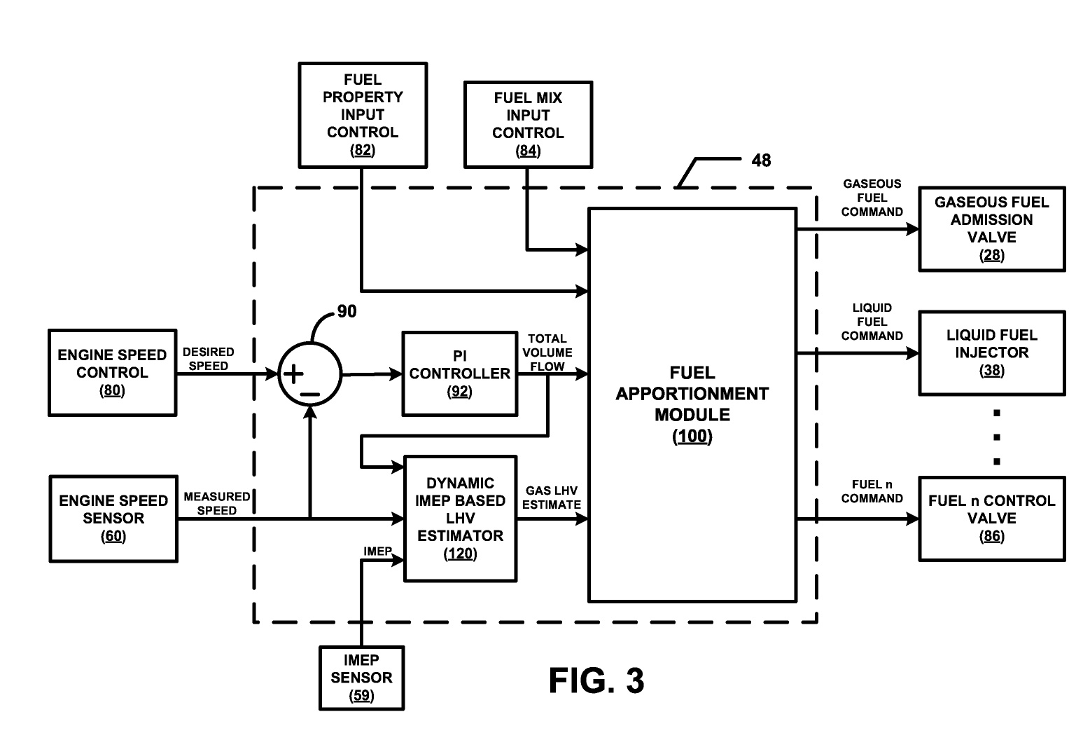

The ECM 48 and the accompanying control elements of FIG. 2 may be used to implement a fuel apportionment control system for the multi-fuel engine system 10 that may provide the fuels to the engine 12 according to fuel mix data provided at the fuel mix input control 84. As can be seen from the schematic illustrations of FIGS. 3-5, the ECM 48 may be programmed to include various control modules (illustrated as the blocks within the dashed lines of the ECM 48) for implementing the logic of the fuel apportionment control strategy. Though illustrated as being contained within a single ECM 48, the control modules of FIGS. 3-5 may be distributed across multiple processing elements of the multi-fuel engine system 10 if necessary based on the requirements of a particular implementation. However, for the purpose of illustration, the ECM 48 will be discussed herein as a single processing element.

The fuel apportionment system may begin at an adder 90 of the ECM 48. The adder 90 may perform a comparison of the desired speed for the engine 12, input as a desired speed control signal from the engine speed control 80, to the current measured speed of the engine, the current speed of the engine provided to the ECM 48 by the engine speed sensor 60. The adder 90 may subtract the measured speed of the engine 12 from the desired speed to determine a speed error. The speed error may have a positive value if the engine 12 is running slower than desired or a negative value if the engine 12 is running faster than necessary. The speed error may occur due to a change in the desired speed from the engine speed control 80, or due to a change in the actual speed of the engine 12 as measured by the engine speed sensor 60 caused by an event such as a change in the load or torque on the engine 12.

The calculated speed error may be transmitted from the adder 90 to a single proportional-integral (PI) controller 92 of the ECM 48. The PI controller 92 may be configured to use the desired speed and the speed error to determine an input power to be provided by the available fuels to cause the measured engine speed to increase or decrease toward the desired engine speed at a response rate specified during the configuration of the PI controller 92. The specific programming of the PI controller 92 to calculate the input power for the engine 12 is within the understanding of those skilled in the art, and a detailed discussion of PI controller programming methods is not provided herein. It should be noted also that the use of a PI controller is exemplary, and other types of controllers and control calculations capable of determining an input power for the engine 12 may be implemented in the fuel apportionment control strategy in accordance with the present disclosure.

The input power determined by the PI controller 92 for the engine 12 may be used, along with other input data, by a fuel apportionment module 100 to apportion the power demand between the available fuels. The fuel apportionment module 100 may also use data input at the fuel property input control 82 and the fuel mix input control 84 in determining the amount of each fuel to be provided to the engine 12. Additionally or alternatively, data regarding the fuel properties may be stored in the memory 72 of the ECM 48. For example, the fuel property data input for each of the n available fuel at the fuel property input control 82 includes a measure of the chemical energy content or fuel quality of the fuel in the form of a lower heating value LHVᵢ, a measure of the fuel's density, such as the mass density Dᵢ or specific gravity SGᵢ of the i^{th} fuel, and any other fuel property data necessary to accurately regulate the flow of the fuels per the calculated apportionment.

In a generalized embodiment of the fuel apportionment module 100 for a fuel apportionment strategy for n fuels, the fuel mix data entered at the fuel mix input control 84 indicates the portion of the input power to be provided by each of the n available fuels. To facilitate adaptability for use of additional or alternate fuels in the multi-fuel engine 12, the system 10 may be configured to allow the operator to enter a fuel substitution ratio FSRᵢ at the fuel mix input control 84 for each of the n fuels. Each fuel substitution ratio FSRᵢ may have a value between 0.00 and 1.00 representing the portion of the required input power to be provided by the corresponding fuel. To ensure that 100% of the input power requirement is provided by the fuels, and that excess fuel is not provided to the engine 12, the ECM 48 and the fuel mix input control 84 may be configured to restrict entry of values of the fuel substitution ratio FSRᵢ to those satisfying the equation:

Σᵢ₌₁ⁿFSRᵢ=1 (1)

As will be discussed below, a value of the fuel substitution ratio FSRᵢ equal to 0.00 indicates that the i^{th} fuel will not be used to provide power to the engine 12, and a value of the fuel substitution ratio FSRᵢ equal to 1.00 indicates that the i^{th} fuel will provide 100% of the input power to the engine 12 without substitution of any of the other available fuels.

When the input power is transmitted to the fuel apportionment module 100 from the PI controller 92 (as, e.g., a total fuel volume flow), the fuel apportionment module 100 retrieves the fuel property and fuel mix data necessary to apportion the available fuels. The fuel apportionment module 100 uses the data to determine a mass flow rate m^{•}ᵢ for each fuel based on the following equation:

$${\dot{m}}_{i} = \frac{{FSR}_{i} \times Input Power}{{LHV}_{i}} \qquad ( 2 )$$

where FSRᵢ is the unit less fuel substitution ratio for the i^{th} fuel, Input Power is the commanded power transmitted from PI controller 92 having units of energy per unit of time, and LHVᵢ is the lower heat value for the i^{th} fuel having units of energy per unit of mass. Equation (2) yields the mass flow rate m^{•}ᵢ in mass per unit of time required for each of the i fuels to provide the required portion of the commanded power to the engine 12.

After determining the mass flow rate \dot{m}ᵢ for each available fuel, the fuel apportionment module 100 formats commands for the actuators of fuel flow control devices (e.g., the gaseous fuel admission valve 28, the liquid fuel injector 38, and/or the fuel n control valve 86) to cause the devices to provide the required mass flow to the engine 12. The fuel apportionment module 100 may be configured to convert each mass flow rate \dot{m}ᵢ into a control signal that will cause the corresponding fuel flow control device to output fuel at the appropriate rate. The conversions in the fuel apportionment module 100 may incorporate lookup tables, conversion equations utilizing additional fuel properties, or any other appropriate conversion logic necessary to generate the control signals.

As shown in FIG. 3, the fuel apportionment module 100 may transmit a separate control signal to each of the fuel flow control devices. Consequently, a gaseous fuel command may be transmitted to the gaseous fuel admission valve 28 to cause the valve 28 to open to the position necessary to add the appropriate amount of gaseous fuel to the intake air in the intake port 18 and subsequently to the cylinder 14. Similarly, the liquid fuel command may be transmitted to the liquid fuel injector 38 to cause the injection of the required amount of liquid fuel into the combustion chamber of the cylinder 14. For each additional available fuel up to the n^{th} fuel, the fuel apportionment module 100 transmits a fuel command to the corresponding fuel n control valve 86. For each fuel having a fuel substitution ratio FSRᵢ, and correspondingly a mass flow rate \dot{m}ᵢ, equal to zero, the fuel apportionment module 100 transmits a fuel command causing the corresponding fuel flow control device to prevent fuel flow to the engine 12.

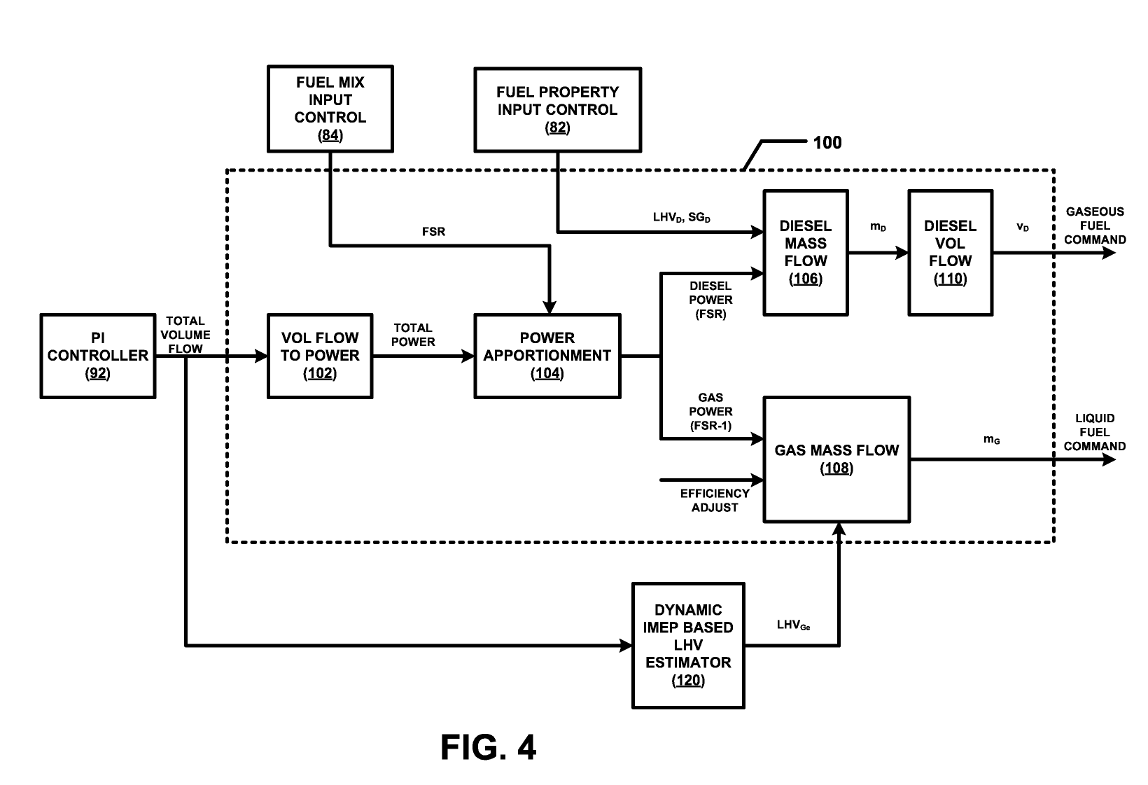

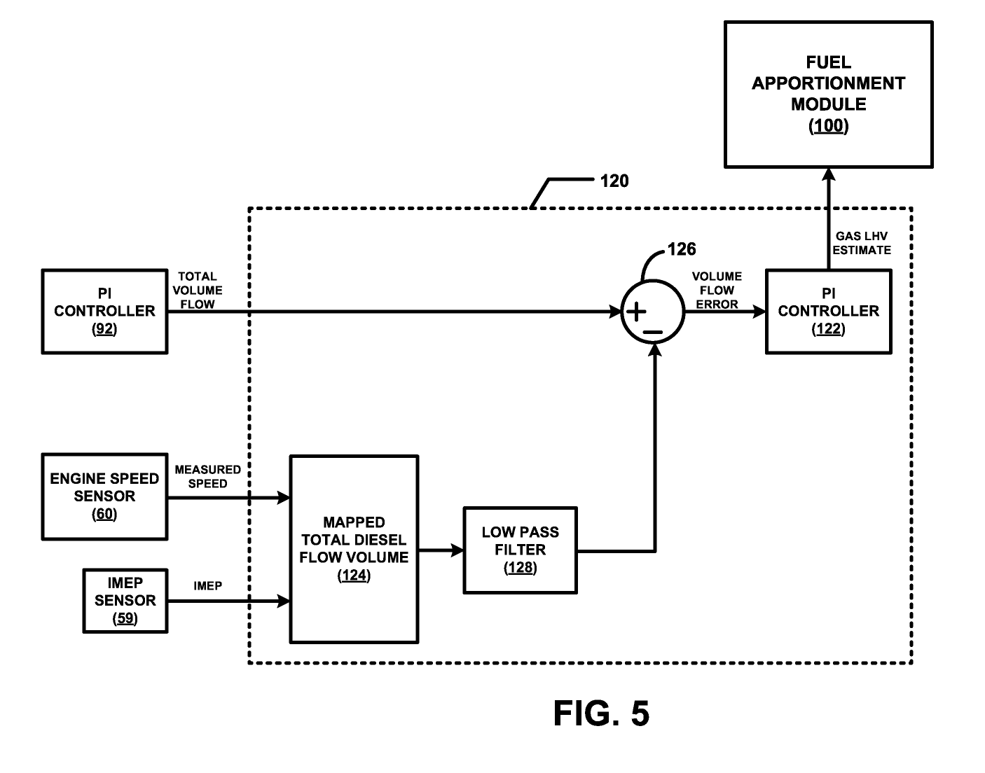

In the exemplary multi-fuel engine 12, the engine 12 may primarily run on natural gas and have diesel fuel available as a backup or secondary fuel source to power the engine 12 or to provide a pilot amount of fuel to ignite the gaseous fuel and air mixture. In such multi-fuel engines 12, the fuel apportionment control strategy may be modified to acknowledge the design of the engine 12 and the use of exactly two fuels to provide power to the engine 12. The exemplary control elements shown in FIGS. 4-5, which provide a greater detail of the fuel apportionment module 100 and a dynamic IMEP-based LHV estimator 120, are shown for a multi-fuel engine operating, primarily, using a diesel fuel source and a natural gas fuel source.

Turning to FIG. 4, the fuel apportionment module 100 receives the total volume flow command from the PI controller 92 and inputs the total volume flow to a volume flow to power conversion module 102. The volume flow to power conversion module 102 then converts the total volume flow to a total power command for input to a power apportionment module 104. The power apportionment module 104 receives at least one fuel substitution ration (FSR) from, for example, the fuel mix input control 84. Where the engine 12 is designed for only two fuels, a single fuel substitution ratio FSR may be used to indicate the amount of the secondary fuel source to substitute for the primary fuel source. Consequently, in the exemplary natural gas/diesel fuel dual fuel engine 12, a fuel substitution ratio FSR equal to 20%, or 0.20, for example, may be specified at the fuel mix input control 94 to supply power to the engine 12 at an 80% natural gas/20% diesel fuel apportionment.

The power apportionment module 104 may then output a diesel power command to a diesel mass flow module 106 and a gas power command to a gas mass flow module 108. At the fuel property input control 82, an operator may input an initial lower heat valve LHV_{Gi} and a specific gravity SG_{G} for the natural gas supply, and a lower heat value LHV_{D} and a specific gravity SG_{D} for the diesel fuel among other relevant fuel property data. The fuel mix data entered at the fuel mix input control 94 indicates the portion of the input power to be provided by the natural gas and the diesel fuel.

In the duel fuel engine example, the calculation of the mass flow rates \dot{m} of the fuels performed at the fuel apportionment module 100 may also be modified to account for the use of two fuels and the input of a single fuel substitution ratio FSR. In this implementation, equation (2) may be modified into separate mass flow rate in equations for the primary and secondary fuels. The diesel mass flow module 106 may determine the secondary diesel fuel mass flow rate \dot{m}_{D.} Said fuel mass flow rate \dot{m}_{D} may be calculated as follows:

$${\dot{m}}_{D} = \frac{FSR \times Input Power}{{LHV}_{D}} \qquad ( 3 )$$

The mass flow rate \dot{m}_{D} is then output to a diesel volume flow module 110 to determine a diesel volume flow rate v_{D} to be used by actuators commanding the liquid fuel injector 38 to provide the proper liquid fuel apportionment based on the FSR.

Turning to the gaseous end of the fuel apportionment, the gas mass flow module 108 also receives the FSR from the power apportionment module 104. In calculation of the gas mass flow, the gas mass flow module 108 may use (1-FSR) to determine the portion of the power which is to come from gas; therefore, the power portion from the liquid fuel (FSR) and the power portion from the gaseous fuel (1-FSR) will equal 1 (100%) when summed. In addition, the gas mass flow module 108 may receive an efficiency adjustment, which may be factored into the output gas mass flow (m_{G}) during calculations. The general equation for determining the primary natural gas mass flow rate \dot{m}_{G} may utilize the single fuel substitution ratio FSR as follows:

$${\dot{m}}_{G} = \frac{( 1 - FSR ) \times Input Power}{{LHV}_{Ge}} \qquad ( 4 )$$

In equation 4, a gaseous fuel lower heating value estimation (LHV_{Ge}) is used, which is input to the gas mass flow module 108 by the dynamic IMEP-based LHV estimator 120.

The dynamic IMEP-based LHV estimator 120 is shown in greater detail in FIG. 5. The dynamic IMEP-based LHV estimator receives input of the total volume flow from the first PI controller 92 and compares the total volume flow with a mapped total diesel flow volume to determine a volume flow error. The volume flow error is then used by a second PI controller 122 of the dynamic IMEP-based LHV estimator to determine the gas LHV estimate (LHV_{Ge}) for the gaseous fuel.

For determining a mapped diesel flow volume, the dynamic IMEP-based LHV estimator 120 includes the module 124, which receives input of the measured speed from the engine speed sensor 60 and an IMEP value for the current cycle of the engine 12 from the IMEP sensor 59. The mapped total diesel flow volume module 124 includes a table populated with total volume flow values for the engine 12 when running in a pure diesel mode. The data within the module 124 relates a total volume flow value to a given engine speed and IMEP value. The module 124 uses the input measured speed and IMEP values and determines a total diesel flow volume for the current engine cycle. The determined total diesel flow volume is then fed to an adder 126, where it is compared with the total volume flow from the first PI controller 92 to determine a volume flow error. In some examples, the dynamic IMEP-based LHV estimator 120 may include a low pass filter 126 to ensure that the output total diesel flow volume is calculating at the same speed as the total volume flow output by the first PI controller 92.

The volume flow error is then input to the second PI controller 122. The second PI controller 122 uses the volume flow error to determine the LHV_{Ge} value, which is used to correct discrepancies in gaseous fuel mass flow due to fluxuations in gaseous lower heat values. If the gas LHV_{Ge} is the expected value (e.g., the normal LHV of natural gas), then the error should be zero, meaning that the LHV_{Ge} value will equal the normal LHV of natural gas. However, if the volume flow error is non-zero, then the LHV_{Ge} value is altered to either raise or lower the output of natural gas to account for discrepancies due to a changing LHV of the gas. If the volume flow error is greater than zero, then the gas mass flow will be lower than the expected gas mass flow. Alternatively, if the volume flow error is less than zero, then the gas mass flow will be lower than the expected gas mass flow. The ECM 48 will continue to update the LHV_{Ge} until the error is zero.

Using equations (3) and (4), the mass flow rates \dot{m}_{G}, \dot{m}_{D} should yield 100% of the commanded input power output from the PI controller 92. Based on the mass flow rates \dot{m}_{G}, \dot{m}_{D}, the fuel apportionment module 100 will generate the appropriate control signals and transmit the corresponding gaseous fuel commands and liquid fuel commands to the gaseous fuel admission valve 28 and the liquid fuel injector 38, respectively.

FIG. 5 shows an example block diagram for a method 200 for controlling fuel flow in the multi-fuel engine 12. In the example method 200, the multi-fuel engine 12 is provided with power by a gaseous fuel source (e.g., a hydrocarbon fuel such as natural gas) and a secondary fuel source (e.g., a liquid fuel such as diesel fuel). The method 200 and its associated steps may be performed using any combination of hardware associated with the multi-fuel engine 12 and the ECM 48 and/or software executed by, for example, the processor 70 of the ECM 48.

At block 210, an input power for operating the multi-fuel engine 12 is determined for a desired engine speed. The desired engine speed may be provided by the engine speed control 80. The input power may be determined using the PI controller 92 after summing, at the adder 90, the desired speed with the measured speed provided by the engine speed sensor 60.

A secondary fuel flow value (e.g., the diesel mass flow m_{D}) may be determined using the fuel apportionment module 100 (block 220). The secondary fuel flow rate may be determined using the power input, the FSR value provided by the fuel mix input control 84, and any other data provided by the fuel property input control 82 (e.g., the LHV_{D}).

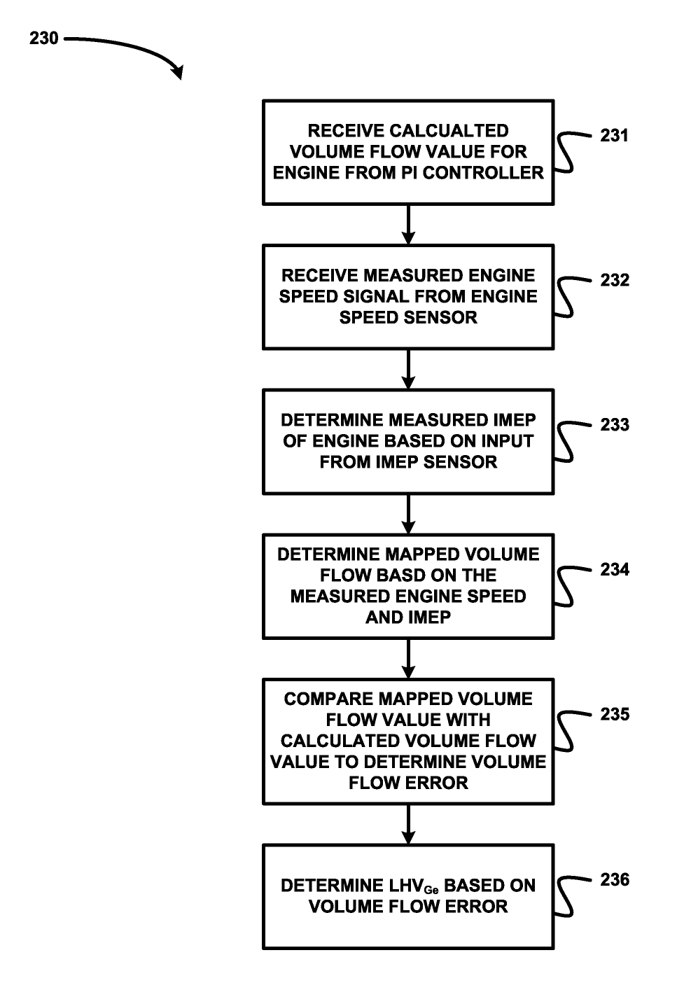

At block 230, the method 200 includes determining the estimated LHV for the gaseous fuel (LHV_{Ge}). The steps involved in determining the estimated LHV are further shown in FIG. 7, which provides a method 230 for dynamically determining the lower heating value of the gaseous fuel in the multi-fuel engine 12. The dynamic IMEP-based LHV estimator 120 receives a calculated volume flow value from the multi-fuel engine 12 via the PI controller 92 (block 231). The dynamic IMEP-based LHV estimator 120 also receives a measured speed value from the engine speed sensor 60 and determines an IMEP value based on input from the IMEP sensor 59 (blocks 232, 233).

The dynamic IMEP-based LHV estimator 120 may determine a mapped volume flow value based on the measured engine speed and the IMEP value. Determining the mapped volume flow value may include comparing the measured engine speed and the IMEP with a look up table including a plurality of predetermined engine speed values, a plurality of predetermined IMEP values, and a plurality of predetermined volume flow values, each of the plurality of predetermined volume flow values associated with at least one of the plurality of predetermined engine speed values and at least one predetermined IMEP value. In some such examples, determining the mapped volume flow may further include determining a mapped engine speed value, the mapped engine speed value being a member of the plurality of predetermined engine speed values which is most similar to the measured engine speed value, determining a mapped IMEP value, the mapped IMEP value being a member of the plurality of predetermined IMEP values which is most similar to the measured IMEP value, and determining the mapped volume flow value at which of the plurality of predetermined volume flow values is associated with the mapped engine speed value and the mapped IMEP value.

Further, the method 230 continues by comparing the mapped volume flow value with the calculate volume flow value to determine a volume flow error (block 235). Using, at least, the volume flow error, the estimated LHV of the gaseous fuel is determined (block 236).

The gaseous fuel flow rate is then determined using the determined estimated LHV, the power, and the FSR (block 240). The gaseous fuel flow rate is then output to the gas fuel admission valve 28 (block 250) and the secondary fuel flow rate is output to the liquid fuel injector 38 (block 260).

### INDUSTRIAL APPLICABILITY

The present generally relates to multi-fuel engines capable of operating with liquid fuel, with gaseous fuel, and with a mixture of liquid and gaseous fuels, and, more particularly, to systems and methods for controlling and adapting apportionment of the multiple fuels to the multi-fuel engine based on a lower heating value of a gaseous fuel. The disclosed systems and methods are greatly useful in providing greater efficiency, lower emissions, and cost effectiveness for multi-fuel engines.

In some multi-fuel engines, expensive gaseous fuel analyzers are needed to monitor and, subsequently, input LHV values for proper usage. As described in great detail above, the disclosed systems and methods eliminate the need for such devices as the LHV of gaseous fuels are dynamically estimated and said values are used to alter the gas mass flow within the system. Additionally, the disclosed systems and methods may ensure for accurate energy-based gas substitutions for speed governing while the gas LHV is changing. As such, the systems and methods may provide cost effective control systems and also provide robust and accurate engine protection; as an improper gas mass flow may cause damage to the engine.

It will be appreciated that the present disclosure provides systems and methods for controlling and adapting apportionment of the multiple fuels to the multi-fuel engine based on a lower heating value of a gaseous fuel. While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for controlling fuel flow in a multi-fuel engine, the multi-fuel engine being provided power by, at least, a gaseous fuel source and a secondary fuel source, the method comprising:
determining an input power for operating the multi-fuel engine at a desired engine speed;
determining a secondary fuel flow rate for the secondary fuel source based on, at least, the input power and a specified fuel substitution ratio for apportioning the secondary fuel source and the gaseous fuel source;
determining an estimated lower heating value (LHV) of the gaseous fuel by, at least, comparing a mapped volume flow value with an input volume flow value, the input volume flow value based on the input power; and
determining a gaseous fuel flow rate for the gaseous fuel, the gaseous fuel flow rate based on, at least, the specific fuel substitution ratio and the estimated LHV of the gaseous fuel source.

2. The method of claim 1, wherein determining the estimated LHV of the gaseous fuel further includes:
receiving a measured engine speed from an engine speed sensor associated with the multi-fuel engine;
determining a measured indicated mean effective pressure (IMEP) of the multi-fuel engine based on input from a sensor; and
determining the mapped volume flow value based on the measured engine speed and the IMEP.

3. The method of claim 2, wherein determining the mapped volume flow value includes comparing the measured engine speed and the IMEP with a look up table including a plurality of predetermined engine speed values, a plurality of predetermined IMEP values, and a plurality of predetermined volume flow values, each of the plurality of predetermined volume flow values associated with at least one of the plurality of predetermined engine speed values and at least one predetermined IMEP value.

4. The method of claim 3, wherein the determining the mapped volume flow value further includes determining the mapped volume flow by:
determining a mapped engine speed value, the mapped engine speed value being a member of the plurality of predetermined engine speed values which is most similar to the measured engine speed value;
determining a mapped IMEP value, the mapped IMEP value being a member of the plurality of predetermined IMEP values which is most similar to the measured IMEP value; and
determining the mapped volume flow value at which of the plurality of predetermined volume flow values is associated with the mapped engine speed value and the mapped IMEP value.

5. The method of claim 1, wherein determining the input power comprises:
receiving the desired engine speed;
determining a measured engine speed of the multi-fuel engine;
determining a speed error equal to a difference between the desired engine speed and the measured engine speed; and
determining the input power based on the measured engine speed and the speed error.

6. The method of claim 1, wherein determining the gaseous fuel flow rate comprises:
determining a portion of the input power of the gaseous fuel based on the specified fuel substitution ratio; and
calculating the gaseous fuel flow rate by dividing the portion of the input power of the gaseous fuel by the estimated LHV of the gaseous fuel.

7. The method of claim 1, further comprising:
outputting the gaseous fuel flow rate to a first actuator of a first fluid flow control device, the first actuator for providing the gaseous fuel to the multi-fuel engine at the gaseous fuel flow rate; and
outputting the secondary fuel flow rate to a second actuator of a second fluid flow control device, the second actuator for providing the secondary fuel to the multi-fuel engine at the secondary fuel flow rate.

8. The method of claim 7, wherein outputting the secondary fuel flow rate to the second actuator comprises outputting the secondary fuel flow rate to an actuator of a fuel injector and outputting the gaseous fuel flow rate to the first actuator includes outputting the gaseous fuel flow rate to an actuator of a fuel control valve.

9. A multi-fuel engine, the multi-fuel engine being provided power by, at least, a gaseous fuel source and a secondary fuel source, the multi-fuel engine comprising:
at least one cylinder;
a fuel injector operatively associated with the at least one cylinder;
a fuel control valve operatively associated with the at least one cylinder;
an engine speed controller configured to output an engine speed control signal indicating a desired engine speed;
a speed controller for determining an input power based on, at least, the desired engine speed;
a fuel mix input controller for providing a specified fuel substitution ratio for the gaseous fuel source and the secondary fuel source;
a lower heating value (LHV) estimator, the LHV estimator determining an estimated LHV of the gaseous fuel by, at least, comparing a mapped volume flow value with an input volume flow value, the input volume flow value based on the input power;
a fuel apportionment module for determining a secondary fuel flow rate for the secondary fuel source based on, at least, the input power and the specified fuel substitution ratio and for determining a gaseous fuel flow rate for the gaseous fuel, the gaseous fuel flow rate based on, at least, the specific fuel substitution ratio and the estimated LHV of the gaseous fuel source;
a first actuator for directing the fuel control valve to output the gaseous fuel to the multi-fuel engine at the gaseous fuel flow rate; and
a second actuator for directing the fuel injector device to output the secondary fuel to the multi-fuel engine at the secondary fuel flow rate.

10. The multi-fuel engine of claim 9, further comprising an engine speed sensor associated with the multi-fuel engine, the engine speed sensor determining a measured speed of the multi-fuel engine.

11. The multi-fuel engine of claim 10, wherein determining the estimated LHV of the gaseous fuel by the LHV estimator further includes:
receiving the measured engine speed from the engine speed sensor;
determining a measured indicated mean effective pressure (IMEP) of the multi-fuel engine based on input from a sensor; and
determining the mapped volume flow value based on the measured engine speed and the IMEP.

12. The multi-fuel engine of claim 11, wherein determining the mapped volume flow value includes comparing the measured engine speed and the IMEP with a look up table including a plurality of predetermined engine speed values, a plurality of predetermined IMEP values, and a plurality of predetermined volume flow values, each of the plurality of predetermined volume flow values associated with at least one of the plurality of predetermined engine speed values and at least one predetermined IMEP value.

13. The multi-fuel engine of claim 12, wherein the determining the mapped volume flow value further includes determining the mapped volume flow by:
determining a mapped engine speed value, the mapped engine speed value being a member of the plurality of predetermined engine speed values which is most similar to the measured engine speed value;
determining a mapped IMEP value, the mapped IMEP value being a member of the plurality of predetermined IMEP values which is most similar to the measured IMEP value; and
determining the mapped volume flow value at which of the plurality of predetermined volume flow values is associated with the mapped engine speed value and the mapped IMEP value.

14. The multi-fuel engine of claim 9, wherein determining the input power by the speed controller includes:
receiving the desired engine speed from the engine speed controller;
determining a measured engine speed of the multi-fuel engine;
determining a speed error equal to a difference between the desired engine speed and the measured engine speed; and
determining the input power based on the measured engine speed and the speed error.

15. The multi-fuel engine of claim 9, wherein determining the gaseous fuel flow rate by the fuel apportionment module comprises:
determining a portion of the input power of the gaseous fuel based on the specified fuel substitution ratio; and
calculating the gaseous fuel flow rate by dividing the portion of the input power of the gaseous fuel by the estimated LHV of the gaseous fuel.

16. The multi-fuel engine of claim 9, wherein the gaseous fuel source is a natural gas fuel source.

17. The multi-fuel engine of claim 9, wherein the second fuel source is a liquid hydrocarbon fuel.

18. A method for dynamically determining the lower heating value (LHV) of a gaseous fuel in a multi-fuel engine, wherein the multi-fuel engine is fueled by, at least, the gaseous fuel and a secondary fuel, the method comprising:
receiving a calculated volume flow value for the multi-fuel engine from a controller associated with the multi-fuel engine;
receiving a measured engine speed from an engine speed sensor associated with the multi-fuel engine;
determining a measured indicated mean effective pressure (IMEP) of the multi-fuel engine based on input from a sensor;
determining a mapped volume flow value based on the measured engine speed and the IMEP;
comparing the mapped volume flow value with the calculated volume flow value to determine a volume flow error;
determining the LHV of the gaseous fuel based on, at least, the volume flow error.

19. The method of claim 1, wherein determining the mapped volume flow value includes comparing the measured engine speed and the IMEP with a look up table including a plurality of predetermined engine speed values, a plurality of predetermined IMEP values, and a plurality of predetermined volume flow values, each of the plurality of predetermined volume flow values associated with at least one of the plurality of predetermined engine speed values and at least one predetermined IMEP value.

20. The method of claim 2, wherein the determining the mapped volume flow value further includes determining the mapped volume flow by:
determining a mapped engine speed value, the mapped engine speed value being a member of the plurality of predetermined engine speed values which is most similar to the measured engine speed value;
determining a mapped IMEP value, the mapped IMEP value being a member of the plurality of predetermined IMEP values which is most similar to the measured IMEP value; and
determining the mapped volume flow value at which of the plurality of predetermined volume flow values is associated with the mapped engine speed value and the mapped IMEP value.
